(19) United States
(12) Patent Application Publication
(10) Pub. No.: US 2010/0135417 A1
(43) Pub. Date: Jun. 3, 2010

(54) PROCESSING OF VIDEO DATA IN RESOURCE CONTRAINED DEVICES

(76) Inventor: Asaf Hargil, Hogla (IL)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/326,654

(22) Filed: Dec. 2, 2008

(51) Int. Cl. H04N 11/02; H04N 11/04

(52) U.S. Cl. 375/240.25; 375/240.01

(57) ABSTRACT

A video processing device may comprise a video processing logic to control the enhancement operations performed on the video processing device. The video processing logic may determine a short term frame rate average value in response to receiving a plurality of video frames. Further, the video processing logic may generate a derivative of the short term frame rate using the short term frame rate value. The video processing logic may then activate monitoring of a processor usage if the derivative of the short term frame rate is below a first threshold value. The video processing logic may then reduce the performance of rendering of the plurality of video frames if a processor usage average value is above a second threshold. While restoring the performance, the video processing logic may restore the enhancement operations in steps after determining that processor resources are available.

### BACKGROUND

A video data processing device may be provisioned in a digital system such as a resource constrained device. In one embodiment, the resource constrained devices may refer to a set of devices, which comprise limited resources such as the processing cycles, memory, and bandwidth to transfer data. The resource constrained devices may include cellular phones, personal digital assistants (PDA), mobile internet devices (MID), cameras, camcoders, digital versatile disc players, compact disc players, and such other similar devices.

The resource constrained devices that process video data may comprise small size display screens to display the video. The small size of the screen may limit the video viewing experience of a user of the resource constrained devices. To avoid or reduce such imitation in video viewing, the video processing devices may use video enhancing techniques. Additional resources may be used to perform enhancing techniques. Matching video processing performance to the available resources on the resource constrained devices may be used to maintain a stable Quality of Service (QoS) values.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates a video processing logic 100, which may support processing of video data in resource constrained devices in accordance with one embodiment.

FIG. 2 illustrates a performance management logic 160, which may support selection of video enhancing techniques to match the available resources on the resource constrained devices in accordance with one embodiment.

FIG. 3 illustrates a flow-chart depicting selection of video enhancing techniques to match the available resources on the resource constrained devices in accordance with one embodiment.

FIG. 4 illustrates a first resource constrained device that supports selection of video enhancing techniques to match the available resources on the resource constrained devices in accordance with one embodiment.

### DETAILED DESCRIPTION

The following description describes techniques to process video data in resource constrained devices. In the following description, numerous specific details such as logic implementations, resource partitioning, or sharing, or duplication implementations, types and interrelationships of system components, and logic partitioning or integration choices are set forth in order to provide a more thorough understanding of the present invention. It will be appreciated, however, by one skilled in the art that the invention may be practiced without such specific details. In other instances, control structures, gate level circuits, and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable storage medium may include any mechanism for storing or transmitting information in a form readable by a machine (e.g., a computing device).

For example, a machine-readable storage medium may include read only memory (ROM); random access memory (RAM); magnetic disk storage media; optical storage media; flash memory devices; electrical, optical forms of signals. Further, firmware, software, routines, and instructions may be described herein as performing certain actions. However, it should be appreciated that such descriptions are merely for convenience and that such actions in fact result from computing devices, processors, controllers, and other devices executing the firmware, software, routines, and instructions.

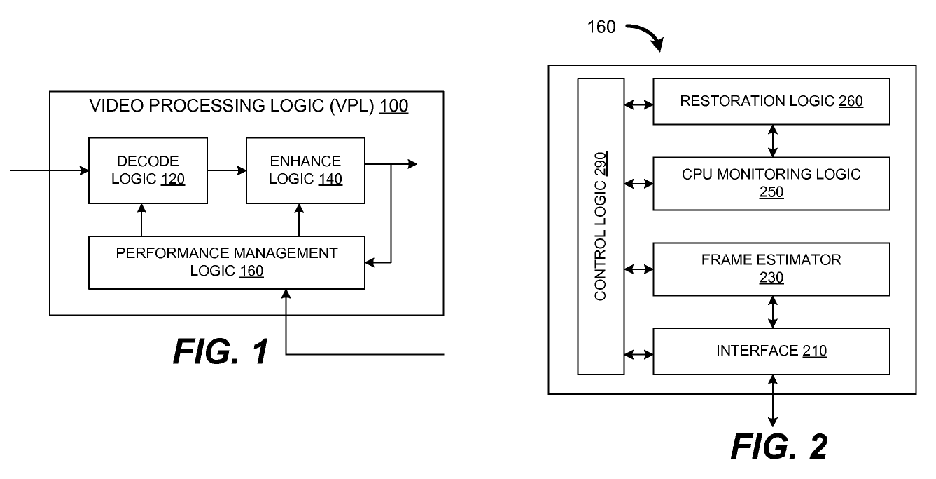

An embodiment of a video processing logic 100 is illustrated in FIG. 1. The video processing logic VPL 100 may comprise a decode logic 120, an enhance logic 140, and a performance management logic 160. In one embodiment, the graphics and/or video processing techniques described herein with reference to the VPL 100 may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device such as mobile internet devices, cell phones, home entertainment devices and such other devices.

In one embodiment, the decode logic 120 may decode composite video data such as streaming video after receiving the composite video data. In one embodiment, the decoded video data may be provided to the enhance logic 140. In one embodiment, the decode logic 120 may separate the luminance and chrominance components of the composite video data received. In one embodiment, the decode logic 120 may process the video data based on Phase Alternating Line (PAL) or National Television System Committee (NTSC), or Sequential Color with Memory (SECAM) standards, or such other standards.

In one embodiment, the enhance logic 140 may receive the decoded data and perform one or more video/image enhancing operations to enhance the quality of the video. In one embodiment, the video/image enhancing operations may comprise scaling, noise reduction, automatic color enhancement, sharpness enhancement, contrast enhancement, skin tone detection, total color control, frame rate conversion and such other enhancements to improve the video viewing experience of the user. In one embodiment, the enhance logic 140 may perform video/image enhancements using one or more enhancing techniques.

In one embodiment, the scaling operation may be performed using, for example, a bilinear interpolation or poly-phase filtering technique. In one embodiment, the poly-phase filtering technique may be computationally intensive to perform but may provide better quality of scaled video compared to that of bilinear interpolation. In one embodiment, the enhance logic 140 may perform all, or some, or none of the enhancing operations based on control signals received from the performance management logic 160. In one embodiment, the enhance logic 140 may also select a technique from an array of techniques available to perform an enhancing operation based on the selection values indicated by the performance management logic 160.

In one embodiment, the enhance logic 140 may receive a control signal, which may indicate that two enhancing operations (for example, scaling and color correction) may be performed. Also, the control signal may comprise a selection value to indicate that a bilinear interpolation enhancement technique is to be used to perform scaling operation. In one embodiment, the enhance logic 140 may receive the control signal and perform scaling operation using bilinear interpolation technique. In one embodiment, the enhance logic 140 may also perform color correction operation in response to receiving the control signal. However, the enhance logic 140 may skip performing other enhancing operations on the video data.

In one embodiment, the performance management logic 160 may monitor the CPU usage states if the performance management logic 160 suspects a CPU saturation state. In one embodiment, the performance management logic 160 may periodically determine the derivative of the short term frame rate average (y′[n]). In one embodiment, the performance management logic 160 may activate monitoring of CPU usage if (y′[n]) is less than a first threshold value. In one embodiment, the performance management logic 160 may reduce the video performance if short term average CPU usage value is above a second threshold value. In one embodiment, the CPU usage may increase for performing other applications such as, for example, an automatic back-up, which may reduce the CPU resources available to perform the enhancement operations.

In one embodiment, the performance management logic 160 may generate control signals, which may be provided to the enhance logic 140 based on the values of the derivative of the short term frame rate average and the short term average CPU usage value. In one embodiment, the performance management logic 160 may generate a control signal which may comprise selection value field. In one embodiment, the selection value field may comprise 6 bits field in which the first four bits starting from the least significant bit (right most bit) may represent an operation identifier (e.g, 0001 for scaling, 0010 for noise reduction, 0011 for automatic color enhancement, 0100 for sharpness enhancement, 0101 for contrast enhancement, 0110 for skin tone detection, 0111 for total color control, and 1000 for frame rate conversion). In one embodiment, the fifth and the sixth bit may represent disable/enable status or a selection value of the enhancement technique that may be used to perform the enhancement operation.

In one embodiment, the performance management logic 160 may determine that two enhancement operations (e.g., scaling and skin tone detection operations) may be performed based on the resources available. In one embodiment, the performance management logic 160 may generate a control signal comprising a first selection field comprising a value equaling 010001 and a second selection field comprising a value 010110. In one embodiment, the four bits (0001) starting from LSB of the first selection field may indicate that the scaling operation is to be performed and the fifth and the sixth bits (=01) may indicate that a bilinear interpolation technique may be used to perform scaling operation. Like wise, in one embodiment, the four bits (0110) starting from LSB of the second selection field may indicate that the skin tone detection operation may be performed and the fifth and the sixth bits (=01) may indicate that a probability distribution of color spaces technique may be used to perform skin tone detection operation.

In one embodiment, the performance management logic 160 may monitor the available resources and may restore the enhancement operations part by part based on the amount of resources available. In one embodiment, the performance management logic 160 may restore the enhancement operations to enhance presentation of the video data to the user.

An embodiment of the performance management logic 160, which may control the operation of the enhance logic 140 is illustrated in FIG. 2. In one embodiment, the performance management logic 160 may comprise an interface 210, a frame estimator 230, a CPU monitoring logic 250, and a restoration logic 260 and a control logic 290. In one embodiment, the performance management logic 160 may be implemented using a set of software instructions. In other embodiment, the performance logic 160 may be implemented using a microcontroller and in yet other embodiment, the performance management logic 160 may be implemented using a field programmable gate array (FPGA) or as an application specific integrated circuit (ASIC) or any a combination thereof or any such similar approaches.

In one embodiment, the interface 210 may receive video frames from the enhance logic 140 and provide the video frames to the frame estimator 230. In one embodiment, the interface 210 may send a signal to the control logic 290 after receiving the video frames. In one embodiment, the interface 210 may receive control signals from the control logic 290 and transfer the control signals to the enhance logic 140 and/or to the decode logic 120. In one embodiment, the interface 210 may perform translations to interface the performance management logic 160 to the decode logic 120 and the enhance logic 140.

In one embodiment, the frame estimator 230 may receive the video frames and determine a current frame rate (CFR), short term frame rate (y[n]), and a derivative of the short term frame rate (y′[n]) and provide the values to the control logic 290. In one embodiment, the frame estimator 230 may determine the current frame rate (CFR) using the Equation (1) below:

CFR=(frame number of the current frame−frame number of the frame received before T seconds)/T Equation (1)

wherein ‘/’ represents a division operator and ‘−’ represents a subtraction operator.

In one embodiment, the frame estimator 230 may determine the short term frame rate average (y[n]) using the estimated frame rate (x[n]) at time ‘n’. In one embodiment, the frame estimator 230 may comprise Infinite Impulse Response (IIR) filter to determine (y[n]). In one embodiment, the frame estimator 230 may determine (y[n]) using the Equation (2) below:

y[n]=0.4*x[n]+0.6*y[n−1] Equation (2)

wherein ‘*’ represents a multiplication operator and ‘+’ represents an addition operator.

In one embodiment, the frame estimator 230 may determine the derivative of the short term frame rate average using the short term frame rate average (y[n]). In one embodiment, the frame estimator 230 may comprise an averaging logic, which may determine (y′[n]) using the Equation (3) below:

y′[n]=(y[n]−y[n−1])/T Equation (3)

wherein ‘/’ represents a division operator and ‘−’ represents a subtraction operator.

In one embodiment, the CPU monitoring logic 250 may monitor the CPU and determine if the configuration is to be reduced based on a ‘start monitor’ signal received from the control logic 290. In one embodiment, the CPU monitoring logic 250 may start the periodic monitoring of the CPU usage. In one embodiment, the ‘start monitor’ signal may be received if the derivative of the short term frame rate average (y′[n]) reaches a negative value. In one embodiment, the CPU monitoring logic 250 may receive a single sample (a[n]) of the CPU usage and determine short term frame rate average of the CPU usage (s[n]) using an IIR filter shown in Equation (4) below:

s[n]=0.5*a[n]+0.5*s[n−1] Equation (4)

In one embodiment, the CPU monitoring logic 250 may provide the short term CPU usage average (s[n]) to the control logic 290.

In one embodiment, the restoration logic 260 may be activated after receiving ‘activate restoration’ signal from the control logic 290. In one embodiment, the restoration logic 260 may receive the short term CPU usage average (s[n]) from the CPU monitoring logic 250 and may determine the resources available. In one embodiment, the restoration logic 260 may generate ‘restore EO’ signal and send the restore EO signal to the control logic 290. In one embodiment, the restoration logic 260 may compare the value of s[n] with the second threshold value and if s[n] is below a threshold value by a safe margin, the restoration logic 260 may start to generate the ‘restore EO’. In one embodiment, the EO portion in the signal may indicate the enhancement operation to be restored. In one embodiment, the restoration logic 260 may restore the enhancement operations one after the other to avoid the possibility of CPU returning to saturation state due to sudden increase in the resource consumption if all or many enhancement options are restored at the same time.

In one embodiment, the control logic 290 may receive the current frame rate (CFR), short term frame rate (y[n]), and a derivative of the short term frame rate (y′[n]) from the frame estimator 230. In one embodiment, the control logic 290 may compare the derivative of the short term frame rate average (y′[n]) with the first threshold value and may generate the ‘start monitor’ signal. In one embodiment, the control logic 190 may check (y′[n]) and may generate the ‘start monitor’ signal if the value of (y′[n]) is negative.

In one embodiment, the control logic 290 may receive the short term CPU usage average (s[n]) and generate a ‘performance reduce’ signal if the short term CPU usage average (s[n]) exceeds the second threshold value. In one embodiment, the control logic 290 may determine the enhancement operations that may be skipped and may also determine the enhancement operations that may be performed. In one embodiment, the control logic 290 may also determine the techniques that may be used to perform the selected enhancement operations.

In one embodiment, the control logic 290 may generate control signals comprising the selection values and may send the control signals to the enhance logic 140. In one embodiment, the control logic 290 may determine to skip all the enhancement operations. In other embodiment, the control logic 290 may determine to perform, for example, two enhancement operations such as the scaling operation and skin tone detection operation. In one embodiment, the scaling operation may be performed using bilinear interpolation and the skin tone detection may be performed using probability distribution of color spaces technique. In one embodiment, the control logic 290 may generate control signals with selection values encoded to represent the enhancement options selected. In one embodiment, the control logic 290 may quickly reduce the performance to match the CPU resources available.

In one embodiment, the control logic 290 may activate the restoration logic 260 after the sending the ‘start monitor’ signal to the CPU monitoring logic 250. In one embodiment, the control logic 250 may activate the restoration logic 260 by sending the ‘activate restoration’ signal. In one embodiment, the control logic 290 may receive ‘restore EO’ signal from the restoration logic 260 and cause the enhance logic 140 to restore the enhancement operation indicted in the ‘restore EO’ signal.

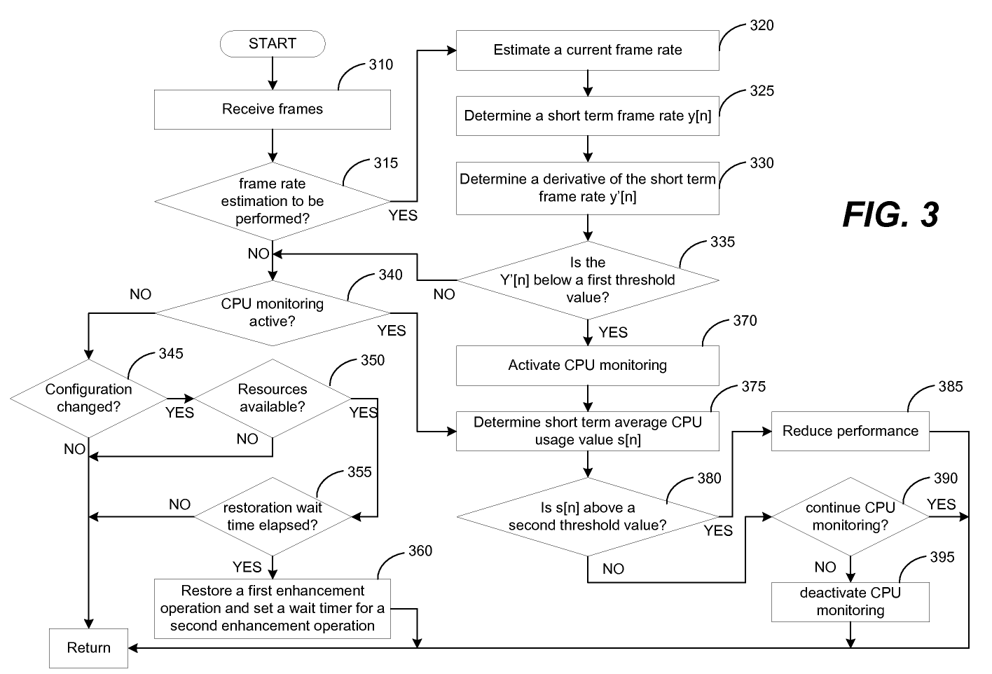

An embodiment of the performance management logic 160, which may control processing of video data in resource constrained devices is illustrated in FIG. 3.

In block 310, the performance management logic 160 may receive the frames. In one embodiment, the interface 210 may send a signal to the control logic 290 after receiving the frames.

In block 315, the control logic 290 may determine whether a periodic or selected frame rate estimation is to be performed and control passes to block 320 if the frame rate estimation is to be performed and to block 340 otherwise.

In block 320, the frame estimator 230 may estimate the current frame rate (CFR). In one embodiment, the frame estimator 230 may determine the current frame rate using the Equation (1) above.

In block 325, the frame estimator 230 may estimate the short term frame rate (y[n]). In one embodiment, the frame estimator 230 may determine the (y[n]) using the Equation (2) above.

In block 330, the frame estimator 230 may estimate the derivative (y′[n]) of the short term frame rate (y[n]). In one embodiment, the frame estimator 230 may determine the (y′[n]) using the Equation (3) above.

In block 335, the control logic 290 may determine whether the (y′[n]) is less the first threshold value and control passes to block 340 if (y′[n]) is not less than the first threshold value and to block 370 if the (y′[n]) is below the first threshold value.

In block 340, the control logic 290 may check whether the CPU monitoring is active and control passes to block 375 if the CPU monitoring is active and to block 345 if the CPU monitoring is not active.

In block 345, the control logic 290 may check whether the configuration changed and control passes to block 350 if the configuration changed and the control returns otherwise. In one embodiment, the control logic 290 may send ‘activate restoration’ signal to the restoration logic 260 in response to detecting that the configuration changed.

In block 350, the restoration logic 260 may check whether the resources are available in response to receiving the activate restoration signal and control passes to block 355 if the resources are available and the control returns otherwise.

In block 355, the restoration logic 260 may check whether the restoration wait time has elapsed and control passes to block 360 if the restoration time has elapsed and the control returns otherwise.

In block 360, the control logic 260 may restore a first enhancement operation and set a wait timer for a second enhancement operation. In one embodiment, the control logic 290 may restore the enhancement operation one after the other in response to receiving each ‘restore EO’ signal from the restoration logic 260.

In block 370, the CPU monitoring logic 250 may be activated on receiving ‘activate restoration’ signal from the control logic 290.

In block 375, the CPU monitoring logic 250 may determine the short term CPU usage average value (s[n]) using the Equation (4) and may send the CPU usage average value to the control logic 290.

In block 380, the control logic 290 may check whether s[n] is above the second threshold value and control passes to block 385 if s[n] is above the second threshold value and to block 390 otherwise.

In block 385, the control logic 290 may cause the performance of the video processing to be reduced. In one embodiment, the control logic 290 may cause all or many or few of the enhancement operations to be skipped and may also select techniques that may consume less resources to be performed.

In block 390, the control logic 290 may determine whether to continue CPU monitoring and control may return to CPU monitoring if the CPU monitoring is to be continued and to block 395 otherwise. In block 395, the control logic 290 may deactivate CPU monitoring.

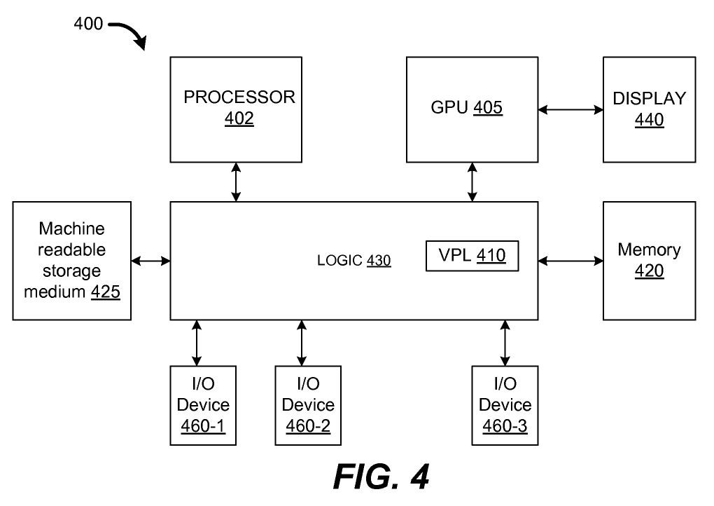

Referring to FIG. 4, a computer system 400 may include a general purpose processor 402 including a single instruction multiple data (SIMD) processor and a graphics processor unit (GPU) 405. The processor 402, in one embodiment, may perform enhancement operations in addition to performing various other tasks or store a sequence of instructions, to provide enhancement operations in a machine readable storage medium 425. However, the sequence of instructions may also be stored in the memory 420 or in any other suitable storage medium.

While a separate graphics processor unit 405 is depicted in FIG. 4, in some embodiments, the graphics processor unit 405 may be used to perform enhancement operations, as another example. The processor 402 that operates the computer system 400 may be one or more processor cores coupled to logic 430. The logic 430 may be coupled to one or more I/O devices 460, which may provide interface the computer system 400. The logic 430, for example, could be chipset logic in one embodiment. The logic 430 is coupled to the memory 420, which can be any kind of storage, including optical, magnetic, or semiconductor storage. The graphics processor unit 405 is coupled through a frame buffer to a display 440.

In one embodiment, the video processing logic VPL 410 may be provisioned within the logic 430. In one embodiment, the VPL 410 may monitor the CPU usage states if the VPL 410 suspects a CPU saturation state. In one embodiment, the VPL 410 may periodically determine the derivative of the short term frame rate average (y′[n]). In one embodiment, the VPL 410 may activate monitoring of CPU usage if (y′[n]) is less than a first threshold value. In one embodiment, the VPL 410 may reduce the video performance if short term average CPU usage value s[n] is above the second threshold value.

In one embodiment, the VPL 410 may monitor the available resources and may restore the enhancement operations part by part based on the amount of resources available. In one embodiment, the VPL 410 may restore the enhancement operations to enhance presentation of the video data to the user.

The video/image processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multi-core processor or as a set of software instructions stored in a machine readable medium.

What is claimed is:

1. A method comprising:
determining a short term frame rate average value (y[n]) in response to receiving a plurality of video frames,
generating a derivative of the short term frame rate average (y′[n]) using the short term frame rate average value,
activating monitoring of a processor usage if the derivative of the short term frame rate average is below a first threshold value,
reducing performance of rendering of the plurality of video frames if a processor usage average value is above a second threshold, and
restoring performance in steps after determining that processor resources are available.

2. The method of claim 1, wherein the short term frame rate average value (y[n]) is determined using an estimated frame rate (x[n]) at a time point ‘n’.

3. The method of claim 2, wherein the short term frame rate average value (y[n]) is determined using an infinite impulse response filter.

4. The method of claim 1, wherein the processor saturation state is indicated if the derivative of the short term frame rate average is below the first threshold value.

5. The method of claim 4, wherein the processor resources are not available to perform enhancement operations if the processor usage average value is above the second threshold.

6. The method of claim 1, wherein performance is reduced by skipping the enhancement operations performed on the plurality of video frames before rendering the plurality of video frames.

7. The method of claim 6, wherein performance is reduced by skipping a sub-set of the enhancement operations performed on the plurality of video frames before rendering the plurality of video frames.

8. An apparatus comprising:
a decode logic to generate a plurality of video frames in response to receiving a video signal,
an enhance logic coupled to the decode logic, wherein the enhance logic is to perform enhancement operations based on a plurality of control signals, and
a performance management logic coupled to the enhance logic, wherein the performance management logic further comprises,
a frame estimator, wherein the frame estimator is to determine a short term frame rate average value in response to receiving a plurality of video frames and to generate a derivative of the short term frame rate average using the short term frame rate value,
a control logic coupled to the frame estimator, wherein the control logic is to,
generate a first signal to activate processor usage monitoring if the derivative of the short term frame rate average is below a first threshold value,
generate second signal to reduce performance of rendering of the plurality of video frames if a processor usage average value is above a second threshold,
generate a third signal to determine if the processor resources are available, and
generate a fifth signal to restore enhancement operations in steps in response to receiving a fourth signal, wherein the fourth signal is generated if the processor resources are available.

9. The apparatus of claim 8, wherein the frame estimator is to determine the short term frame rate average value (y[n]) using an estimated frame rate (x[n]) at a time point ‘n’.

10. The apparatus of claim 9, wherein the frame estimator is to determine the short term frame rate average value (y[n]) using an infinite impulse response filter.

11. The apparatus of claim 8 further comprises a processor monitoring logic, wherein the processor monitoring logic is to activate processor usage monitoring if the derivative of the short term frame rate average is below the first threshold value.

12. The apparatus of claim 11, wherein the processor resources are not available to perform enhancement operations if the processor usage average value is above the second threshold.

13. The apparatus of claim 8, wherein the enhance logic is to reduce performance in response to receiving the second signal, wherein the enhance logic is to reduce performance by skipping the enhancement operations performed on the plurality of video frames before rendering the plurality of video frames.

14. The apparatus of claim 13, wherein the enhance logic is to reduce the performance by skipping a sub-set of the enhancement operations performed on the plurality of video frames before rendering the plurality of video frames.

15. The apparatus of claim 8 further comprises a restoration logic, wherein the restoration logic is to generate the fourth signal if resources are available to perform enhancement operations.

16. The apparatus of claim 15, wherein the enhance logic is perform enhancement operations in response to receiving the fifth signal.

17. A machine-readable storage medium comprising a plurality of instructions that in response to being executed result in a processor comprising:
determining a short term frame rate average value in response to receiving a plurality of video frames,
generating a derivative of the short term frame rate average using the short term frame rate value,
activating monitoring of a processor usage if the derivative of the short term frame rate is below a first threshold value,
reducing performance of rendering of the plurality of video frames if a processor usage average value is above a second threshold, and
restoring performance in steps after determining that processor resources are available.

18. The machine-readable storage medium of claim 17, wherein the short term frame rate average value (y[n]) is determined using an estimated frame rate (x[n]) at a time point ‘n’.

19. The machine-readable storage medium of claim 18, wherein the short term frame rate average value (y[n]) is determined using an infinite impulse response filter.

20. The machine-readable storage medium of claim 17, wherein a drop in quality of service to render the plurality of video frames is due to saturation in the processor usage average value if the derivative of the short term frame rate average is below the first threshold value.

21. The machine-readable storage medium of claim 20, wherein the processor resources available for performing enhancement operation is less than a required processor resources if the processor usage average value is above the second threshold.

22. The machine-readable storage medium of claim 17, wherein performance is reduced by skipping the enhancement operations performed on the plurality of video frames before rendering the plurality of video frames.

23. The machine-readable storage medium of claim 22, wherein performance is reduced by skipping a sub-set of the enhancement operations performed on the plurality of video frames before rendering the plurality of video frames.

24. A system comprising:
a plurality of processors,
a logic coupled to the plurality of processors, wherein the logic comprises a video processing logic, and
a plurality of input-output devices coupled to the logic
wherein the video processing logic is to generate a plurality of video frames in response to receiving a video signal and perform enhancement operations based on a plurality of control signals, wherein the video processing logic is to,
determine a short term frame rate average value in response to receiving a plurality of video frames and to generate a derivative of the short term frame rate average using the short term frame rate value,
generate a first signal to activate processor usage monitoring if the derivative of the short term frame rate average is below a first threshold value,
generate second signal to reduce performance of rendering of the plurality of video frames if a processor usage average value is above a second threshold,
generate a third signal to determine if the processor resources are available, and
generate a fifth signal to restore enhancement operations in steps in response to receiving a fourth signal, wherein the fourth signal is generated if the processor resources are available.

25. The system of claim 24, wherein the video processing logic is to determine the short term frame rate average value (y[n]) using an estimated frame rate (x[n]) at a time point ‘n’ using an infinite impulse response filter.

26. The system of claim 24, wherein the video processing logic is to activate processor usage monitoring if the derivative of the short term frame rate average is below the first threshold value.

27. The system of claim 26, wherein the processor resources are not available to perform enhancement operations if the processor usage average value is above the second threshold.

28. The system of claim 24, wherein the video processing logic is to reduce performance in response to receiving the second signal, wherein the enhance logic is to reduce performance by skipping the enhancement operations performed on the plurality of video frames before rendering the plurality of video frames.

29. The system of claim 28, wherein the video processing logic is to reduce the performance by skipping a sub-set of the enhancement operations performed on the plurality of video frames before rendering the plurality of video frames.

30. The system of claim 24, wherein the video processing logic is to generate the fourth signal if resources are available to perform enhancement operations and to perform enhancement operations in response to receiving the fifth signal.
